(19) United States
(12) Patent Application Publication
(10) Pub. No.: US 2026/0074435 A1
(43) Pub. Date: Mar. 12, 2026

(54) SYSTEM INTERFERENCE CANCELLATION USING METAMATERIALS

(71) Applicant: EPFL, Lausanne (CH)

(72) Inventors: Amir JAFARGHOLI, Lausanne (CH); Romain FLEURY, Lausanne (CH)

(73) Assignee: EPFL, Lausanne (CH)

(21) Appl. No.: 19/322,409

(22) Filed: Sep. 8, 2025

Related U.S. Application Data
(60) Provisional application No. 63/692,655, filed on Sep. 9, 2024.

(51) Int. Cl. H01Q 19/09; H01Q 15/00; H01Q 15/24

(52) U.S. Cl. CPC H01Q 19/09; H01Q 15/0086; H01Q 15/244

(57) ABSTRACT

A system includes a magneto-dielectric metasurface including one or more screens of the plurality of screens including at least one track, with a specific shape, juxtaposed to one face of a layer, configured to suppress at least unwanted incident right-hand circularly polarized plane waves. A system includes a metasurface polarizer including one or more screens of the plurality of screens including a plurality of layers and a plurality of tracks having a specific shape for each layer and interposed between the layers, configured to convert the incident linear/circularly polarized wave into left-hand circular polarization. A system may include a phase shift metasurface including one or more screens of the plurality of screens including at least one layer with at least one track on each side of the layer, configured to cancel the transmitted and reflected waves at the antenna point and suppress the incident wave consequently.

### TECHNICAL FIELD

One or more embodiments according to the present disclosure concerns the field of wireless communications in general, whatever the type of signal and the frequencies used, but it is particularly relevant for GPS signals for which the antenna engineering plays a crucial role in ensuring accurate and reliable satellite positioning. In addition, some embodiments of the present invention can also be adapted to wireless signals emerging from earth, such as mobile phone signals for example, even if they have directions (or angles), in relation to earth, (mainly horizontal) which is different from the (mainly vertical) directions (or angles) of GPS signals.

### BACKGROUND

Today, the commercial applications of satellite positioning systems are rapidly increasing. There are currently four satellite positioning systems, including GPS, GLONASS, GALILEO, and BEIDOU, used in various applications ranging from smart cars and marine navigation to medical systems. Besides, the widespread use of satellite navigation increases the attention to the system's vulnerability to deliberate or unintentional interference. Using a low-power radio, someone can easily interfere with a GPS receiver with the civil C/A code in a short range. Considerable research has been devoted to finding a way to face malicious attacks such as jamming and deception. These interferences are usually received at the GPS antenna from terrestrial sources located at low altitudes or on the Earth. These attacks can block the service or even deceive or divert navigation operations.

Various methods can be used to combat blocking in GPS systems. Still, the choice of method depends on multiple factors such as cost, mechanical constraint, power consumption, and adaptation to the environment in which the method is employed. Among these studies, there are three leading solutions containing signal processing approaches, e.g., adaptive filters and time-frequency methods; the use of a single antenna with a modified radiation pattern, e.g., using a choke ring and high impedance surface; and interferometry and adaptive antennas, e.g., Controlled Reception Pattern Antenna (CRPA), and Artificial Magnetic Conductor (AMC) cavity-backed antenna. The signal processing methods commonly require sophisticated and comprehensive algorithms to cancel unwanted signals effectively, while their robustness severely declines in blind signal classification. Besides the large electrical size of the antenna approach, the single antenna with a modified radiation pattern usually cannot cancel the interference of more than 10 dB. Adaptive antennas are generally an efficient approach despite their cost and complexity; however, their expense is not preferred in compact commercial applications. The array identifies the threat direction and then shapes a Null in the radiation pattern to eliminate the interference power. The array usually comprises some antenna elements, a feeding network, and a processor unit. The necessity of using multiple receivers and feeding networks results in weight and price increments. Moreover, it usually suffers from the required processing time, which directly relates to the number of elements and the direction estimation algorithms. Although the cost of such a complex system is fair for military applications, it is not acceptable for many civil and commercial equipment. Therefore, further investigation is needed to achieve a passive, low-cost solution.

In this context, one purpose of one or more embodiments of the present application is to overcome at least part of the drawbacks of the other approaches by proposing a system to suppress or at least strongly limit deliberate or unintentional interference, preferably in conventional GPS microstrip antennas but possibly in other types of antennas and/or for different types of signals.

This purpose is achieved by a system for interference cancellation, comprising at least one antenna comprising a microstrip patch loaded radially by at least one cover comprising at least one metamaterial, called MTM. Three different approaches have been proposed to implement the cover: the first is a magneto-dielectric material, the second is a metasurface polarizer, and the third is a phase-shift cancellation. The system may thus comprise only one cover type or two or three of the cover types, in particular because the distances at which the screens shall be placed relative to the antenna are not the same for these three types, thus allowing their advantageous combination.

The magneto-dielectric cover is realized using an artificial magnetic conductor (AMC). The magnetic behavior of the capacitively loaded loop, called CLL, shows that it is an effective structure for suppressing unwanted incident right-hand circularly polarized (RHCP) plane waves. New low-profile CLLs are proposed. Making a cross-shaped structure could mitigate all polarizations.

In the second approach, the metasurface polarizer converts the incident linear/circularly polarized wave into left-hand circular polarization (LHCP). Consequently, the second approach causes a significant reduction in receiving unwanted signals due to the RHCP nature of the GPS antenna.

In the third approach, the metasurface structure is designed to cancel the transmitted and reflected waves at the antenna point and suppress the incident wave consequently. In this method, the phase difference between the transmitted and reflected waves should be ±180°.

One or more embodiments of the present invention concern a system for electromagnetic interference cancellation in an antenna suitable for receiving electromagnetic signals having a receiving direction and a frequency band, said system comprising least one cover comprising at least one metamaterial, called MTM, wherein said cover comprises a plurality of screens extending parallel to the receiving direction (and thus generally orthogonal to the plane of the antenna), and distributed radially to surround said antenna in at least one plane not parallel to the receiving direction, each screen comprising at least one plate, called layer of MTM, with at least one track of an electrically conductive material for at least one face of each layer, wherein said at least one cover comprises at least one type of cover among the following cover types:
A magneto-dielectric metasurface comprising screens including at least one track, with a specific shape, juxtaposed to one face of said layer, for suppressing at least unwanted incident right-hand circularly polarized (RHCP) plane waves;
A metasurface polarizer comprising screens including a plurality of layers and a plurality of tracks having a specific shape for each layer and interposed between said layers, for converting the incident linear/circularly polarized wave into left-hand circular polarization (LHCP);
A phase shift metasurface comprising screens including at least one layer with at least one track on each side of the layer, for cancelling the transmitted and reflected waves at the antenna point and suppress the incident wave consequently.

According to another feature, the system further comprises at least a second and/or a third MTM cover according to claim 1, said covers being arranged concentrically around said antenna to combine their respective effects on interferences.

According to another feature, the MTM covers each comprise at least 6, preferably 8, screens surrounding said antenna, said screens having a main plane which is parallel to the receiving direction and tangential to a circle centered on said antenna.

According to another feature, said screens of the magneto-dielectric metasurface comprise Capacitively Loaded Loops forming an Artificial Magnetic Conductor suppressing un-wanted incident right-hand circularly polarized (RHCP) plane waves.

According to another feature, the Capacitively Loaded Loops of said magneto-dielectric metasurface are low-profile CLLs.

According to another feature, said tracks of the Capacitively Loaded Loops of said magneto-dielectric metasurface are arranged in stripes parallel to said receiving direction, thereby forming single-polarized structures mitigating polarized plane waves transmitted parallel to said receiving direction.

According to another feature, said tracks of the Capacitively Loaded Loops of said magneto-dielectric metasurface are arranged in crosses having branches parallel to said receiving direction and branches orthogonal to said receiving direction, to mitigate all polarizations, thereby forming dual-polarized structures suppressing polarized waves in two directions and thus lead to a reduction in both left-hand circular polarization (LHCP) and right-hand circular polarization (RHCP).

According to another feature, said screens of the metasurface polarizer comprise chiral MTM.

According to another feature, said screens of the metasurface polarizer comprise a first dielectric layer and the outer tracks are periodic metallic ribbons on the outer face of the layer, for filtering the parallel component of the electric field, allowing the perpendicular wave to transmit.

According to another feature, said screens of the metasurface polarizer include, on the inner face of this layer, a gapped circular track which is rotated 45 degrees.

According to another feature, the inner (or back) face of the second layer features a ribbon that is oriented perpendicular to the gap angle of the circular structure.

According to another feature, the third layer has a circular structure on its back, identical to the one on the second layer.

According to another feature, the third rotated ribbon and a fourth circular shape further rotate the transmitted field perfectly, with the position of the gap and the rotated ribbon determining the type of polarization output, which in this case is LHCP.

According to another feature, said screens of the phase shift comprise chiral MTM.

According to another feature, the distance between said MTM and the antenna is reduced according to both the near field and the far-field, to obtain a short distance enabling said system to act as a polarizer converter in the near-field in addition to the far-field.

According to another feature, said screens of the phase shift comprise a single-layer MTM cell, which is a dielectric layer provided, on one face, with a plurality of parallel and periodic tracks oriented orthogonally to said receiving direction, and on the opposite face, with a track having a gapped circular (crown) shape, integrated with a ribbon rotated 45 degrees, thereby creating a 180-degree phase shift between the wave transmitted from the front and the wave reflected from the back of the antenna.

Many different types of metamaterial structures could realize the AMC material, the polarizer, and the phase-shift cancellation methods. However, in preferred embodiments of the present disclosure, a low-profile CLL is employed to implement the AMC, while the chiral-engineered material is utilized to realize the polarization conversion and phase shift cancellation. The chiral metamaterials can manipulate the transmitted waves due to their anisotropic essence. The essential features of the suggested antenna are low cost, compact size, ease of design, no need to implement a complex array with sophisticated signal processing, and the use of a simple passive structure. Although the structure is proposed to cancel unwanted signals and interference in GPS applications, this method can be generalized in other wireless applications and through the entire frequency band.

The tracks (3) of electrically conductive material may be metallic tracks, such as ribbons, stripe or any shape and they may advantageously be obtained by a PCB (printed circuit board) printing process widely known.

### BRIEF DESCRIPTION OF THE DRAWINGS

FIG. 1 illustrates the diagram of an antenna connected to the GPS satellites that is interfered with by several sources of interference at a low-altitude antenna.

FIGS. 2A, 2B and 2C depict three schematic examples, in side views, of an antenna equipped with a magneto-dielectric cover in FIG. 2A; or with a polarization conversion metasurface in FIG. 2B, or with a phase-shift cancellation metasurface, in FIG. 2C; according to some embodiments.

FIGS. 3A and 3B present a schematic of a magneto-dielectric-loaded patch antenna in side view and in top view, respectively, according to some non-limiting embodiments, with LA=25, LP=WP=19.8, t=1, h=4, Rg=40, Hd=40, Rout=67, Rin=41, Lf=7, w=1.8, all in mm, FIG. 3C shows the simulation results for the E_{z}^{t} intensity as a function of permittivity (Up) and permeability (Down) for a Lorentz model.

FIG. 4A illustrates the schematic of a low-profile CLL comprising a track in the shape of stripes or ribbons, FIG. 4B shows the design parameters, and the magnitude and phase of S-parameters. H_{C}=56, W_{C}=26.5, L_{CLL}=28.5, W_{CLL}=17.8, Warm=8.7, W0=3.2, g=5.3, Rg=40.0, L=80.0, 1=62.6, t=1.0, w=15.0, d=5.2, a=7.8, r=2.6, R_{C}=45.6, Rg=30.0 all in mm, N=8, θ=360/N=450, FIG. 4C illustrates a front view (top) and a back view (bottom) of a low-profile CLL comprising a track in the shape of crosses, and FIG. 4D shows the Lorentz-model dispersive permittivity, &: real part, &: imaginary part.

FIG. 5A shows the schematic of the screen of a polarizer cell in the non-limiting example of three layers, FIG. 5B shows the simulation results for the polarization conversion by the multi-layer cell, magnitude, and phase, FIG. 5C shows the simulation results for the polarization conversion by the structure. It is assumed that the incident wave propagates in the +z direction.

FIG. 6A shows a schematic of the phase-shift cancellation cell, FIG. 6B shows the simulation results for the phase-shift metasurface by the single-layer cell, magnitude, and phase, and FIG. 6C illustrates the simulation results for the electric field by the structure. It is assumed that the incident wave propagates in the +z direction.

FIG. 7A illustrate a perspective view (top), a top view (middle) and a side view (bottom) of a patch antenna covered by low-profile CLLs (left column) and cross-shaped low-profile CLLs (right column) and FIG. 7B compares the F-parameter.

FIG. 8A depicts a schematic of a patch antenna covered by a metasurface polarizer and FIG. 8B compares the F-parameter of various configurations.

FIG. 9A shows the schematic of a patch antenna covered by a metasurface phase-shift cancellation and FIG. 9B compares the F-parameter

FIG. 10 illustrates a patch antenna covered by a magneto-dielectric metamaterial, a metasurface polarizer and a phase-shift metasurface, according to some embodiments.

### DETAILED DESCRIPTION

As known in the fields of physics and engineering, a metamaterial, or MTM, is a type of material engineered to have a property that is rarely observed in naturally occurring materials. The scientific community tends to agree on the definition of MTM identify them as«composites with a periodic or quasi-periodic architecture, designed to produce an unconventional (static or dynamic) response to specific solicitations». The«geometry» therefore plays a fundamental role in determining the properties of metamaterials. For example, in dynamics, at the same filling fraction (1), the shape (cylindrical, squared, etc.) of the inclusions (or voids) and their distribution in the unit cell (centered, at the edges, etc.) can lead in the dispersion diagram to the opening of frequency bandgaps (frequency regions where the propagation of waves is strongly attenuated) or to curves with negative slope. This allows to attain unconventional behaviors such as negative refraction, topological protection, perfect absorption, etc. They are made from assemblies of multiple elements fashioned from composite materials such as metals and plastics. These materials are usually arranged in repeating patterns, at scales that are smaller than the wavelengths of the phenomena they influence. Metamaterials derive their properties not from the properties of the base materials, but from their newly designed structures. and unit cells. The unusual properties of metamaterials generally arise from the resonant response of each unit cell and/or their spatial arrangement. Their precise shape, geometry, size, orientation and arrangement gives them their smart properties capable of manipulating electromagnetic waves: by blocking, absorbing, enhancing, or bending waves, to achieve benefits that go beyond what is possible with conventional materials.

Appropriately designed metamaterials can affect waves of electromagnetic radiation or sound in a manner not observed in bulk materials. Those that exhibit a negative index of refraction for particular wavelengths have been the focus of a large amount of research. These materials are known as negative-index metamaterials. An electromagnetic metamaterial affects electromagnetic waves that impinge on or interact with its structural features, which are smaller than the wavelength. To behave as a homogeneous material accurately described by an effective refractive index, its features must be much smaller than the wavelength.

The resonance response allows considering the local effective material parameters (permittivity and permeability). The resonance effect related to the mutual arrangement of elements is responsible for Bragg scattering, which underlies the physics of photonic crystals, another class of electromagnetic materials. Unlike the local resonances, Bragg scattering and corresponding Bragg stop-band have a low-frequency limit determined by the lattice spacing. The subwavelength approximation ensures that the Bragg stop-bands with the strong spatial dispersion effects are at higher frequencies and can be neglected. The criterion for shifting the local resonance below the lower Bragg stop-band make it possible to build a photonic phase transition diagram in a parameter space, for example, size and permittivity of the constituent element. Such diagram displays the domain of structure parameters allowing the metamaterial properties observation in the electromagnetic material.

Electromagnetic metamaterials comprise (not exclusively) the following different classes:
Negative refractive index or Negative-index metamaterials (NIM) are characterized by a negative index of refraction. Other terms for NIMs include “left-handed media”, “media with a negative refractive index”, and “backward-wave media”. NIMs where the negative index of refraction arises from simultaneously negative permittivity and negative permeability are also known as double negative metamaterials or double negative materials (DNG).
Single negative (SNG) metamaterials have either negative relative permittivity (Er) or negative relative permeability (μr), but not both. They act as metamaterials when combined with a different, complementary SNG, jointly acting as a DNG.
Hyperbolic metamaterials (HMMs) have a dispersion relation in wavevector space forming a hyperboloid and they behave as a metal for certain polarization or direction of light propagation and behave as a dielectric for the other due to the negative and positive permittivity tensor components
Bandgap or Electromagnetic Bandgap Metamaterials (EBG or EBM) comprise either photonic crystals (PC) or left-handed materials (LHM) and control light propagation in specific, designed directions and bandgaps at desired frequencies.
Double positive medium (DPS) do occur in nature, such as naturally occurring dielectrics, and their permittivity and magnetic permeability are both positive, with a wave propagation in the forward direction.
Chiral: The term chiral refers to mirror images which are non-superposable. Generally, a chiral response is a consequence of 3D geometrical chirality of metamaterials composed by embedding 3D-chiral structures in a host medium and showing specific polarization effects.
Frequency selective surface-based (FSS based) metamaterials block signals in one waveband and pass those at another waveband, allowing for optional changes of frequencies in a single medium, rather than the restrictive limitations of a fixed frequency response.

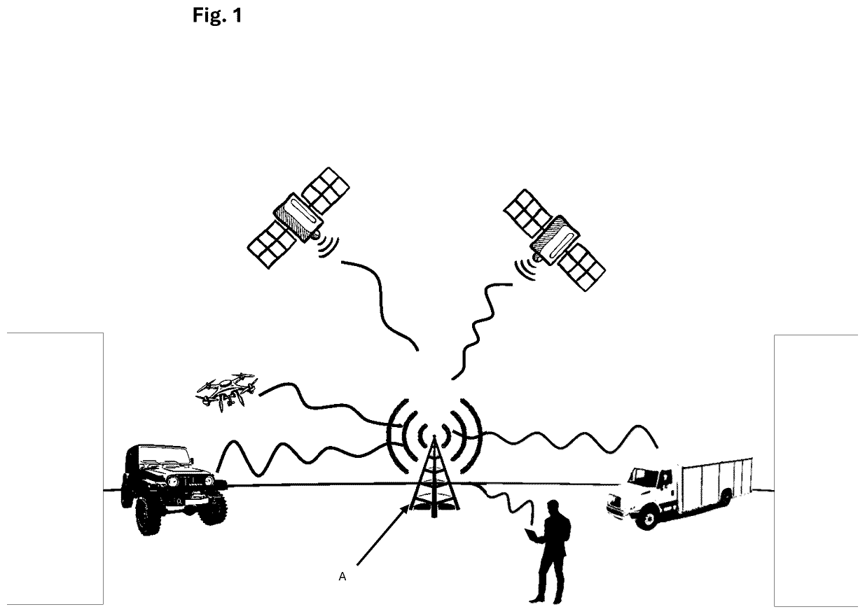

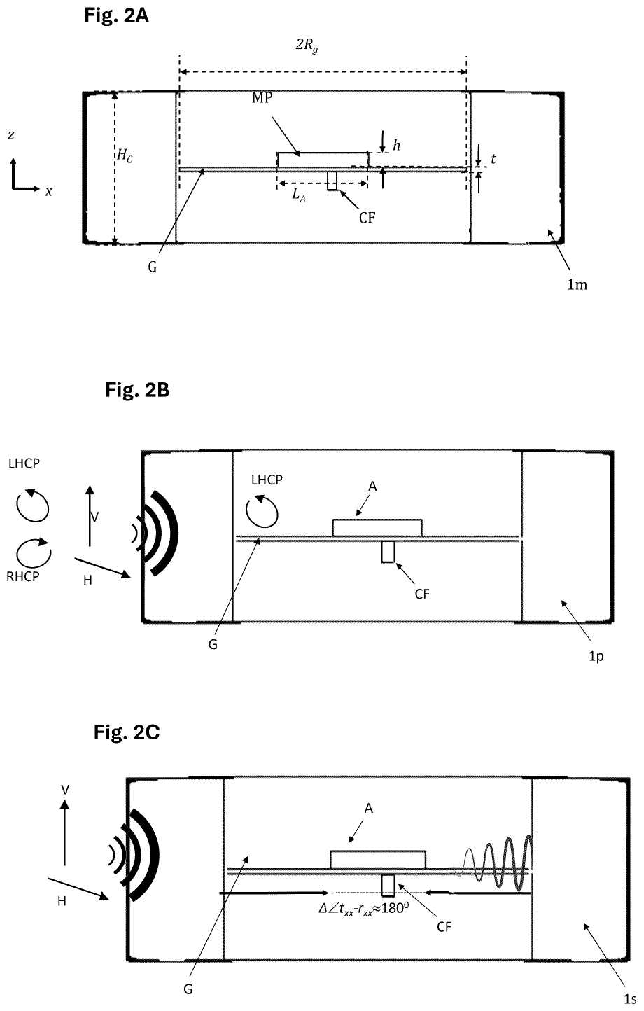

While GPS satellites are located at high altitudes, sources of interference are typically placed on the ground or at lower altitudes, FIG. 1. To ensure secure communication, it is imperative to specifically address interference at the azimuth plane, allowing for the preservation of GPS signals. The need for a solution capable of effectively suppressing unwanted signals within elevation angles of +10° holds significant promise in improving the reliability and performance of the antenna system. Thus, a passive, low-cost structure that can effectively mitigate unwanted signals could satisfy the security demands of most scenarios. In the following, we will show how metamaterials can help realize such a structure. All the suggested methods are depicted in FIG. 2. In this figure, the background physics behind all of these ways are illustrated.

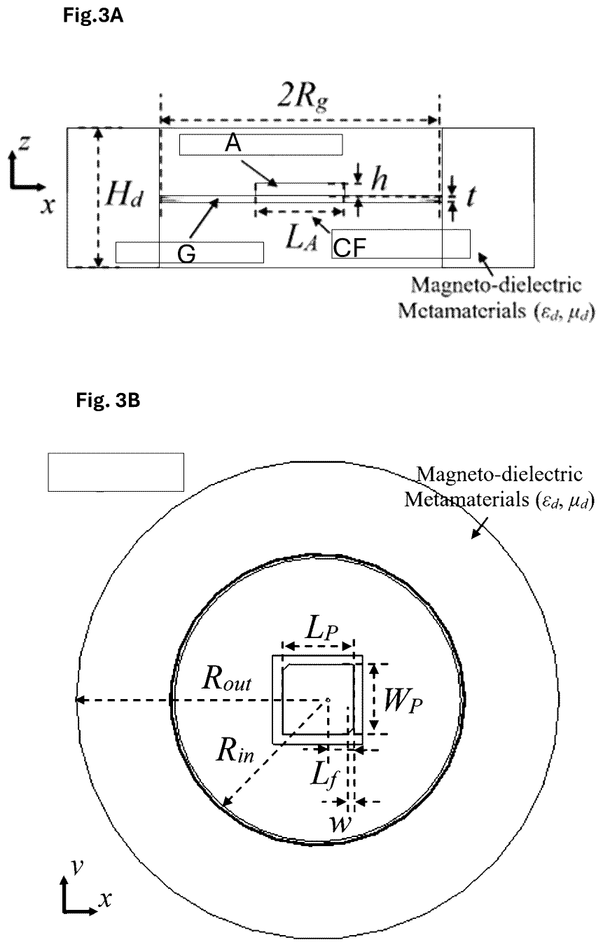

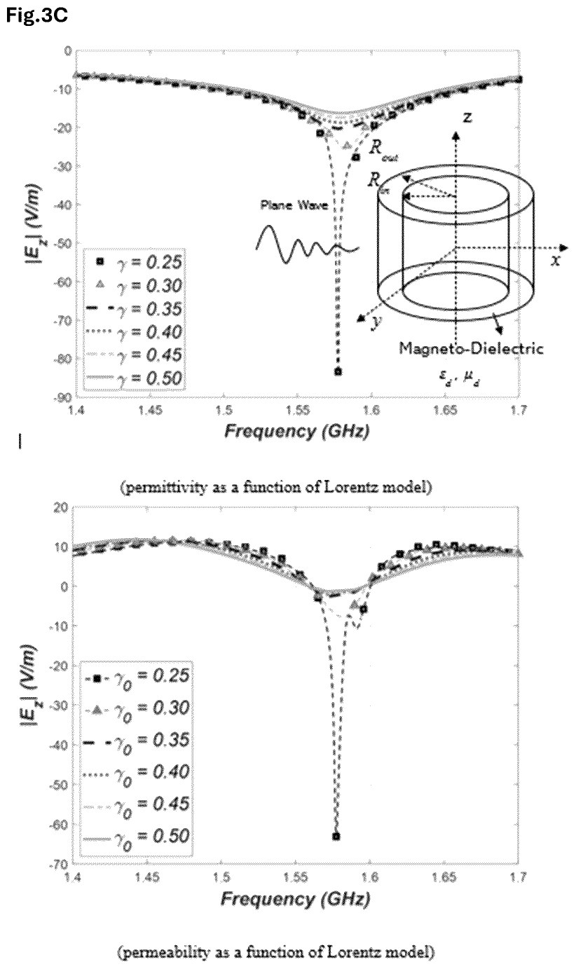

Magneto-dielectric Metamaterial: Let's consider a circularly polarized truncated microstrip patch antenna, as depicted in FIG. 3A. It is assumed that a single-layer cylindrical magneto-dielectric cover loads the antenna. The cover has a constitutive parameter of εᵣ and μᵣ that behave like the Lorentz model. The metamaterial cover is placed in the x-y plane to suppress the incoming plane waves. As a result, the unwanted interference is expected to be eliminated, and the antenna receives the satellite signals without disturbing the horizon.

Here, the effects of cover permittivity/permeability on the antenna's performance are numerically investigated. A microstrip antenna with substrate permittivity of 21 (ceramic) and thickness of 4 mm is considered. An ideal bulk MTM cover loads the antenna. An air gap between them is deemed to diminish unwanted interaction between the MTM cover and the surface wave of the patch ground plane. However, the air gap length can be neglected as the dimension is considerably smaller than the operating wavelength.

It is known that a microstrip patch antenna radiates mostly from the equivalent magnetic current at the aperture, and the magnetic loading has no considerable effects on the radiating electric field. Therefore, to avoid unwanted disturbance in the antenna radiation while addressing the interference suppression, we replaced a magneto-dielectric material with a magnetic material with the permittivity of εᵣ≈1 and permeability of μᵣ for our numerical analysis. The analytical results show that the magneto-dielectric material with the Lorentz model behavior could be employed to suppress the unwanted waves at the antenna.

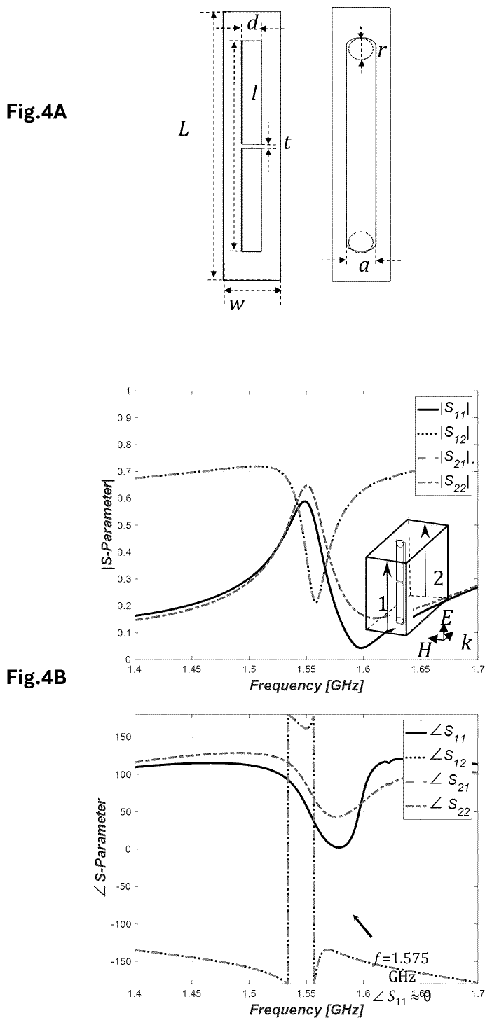

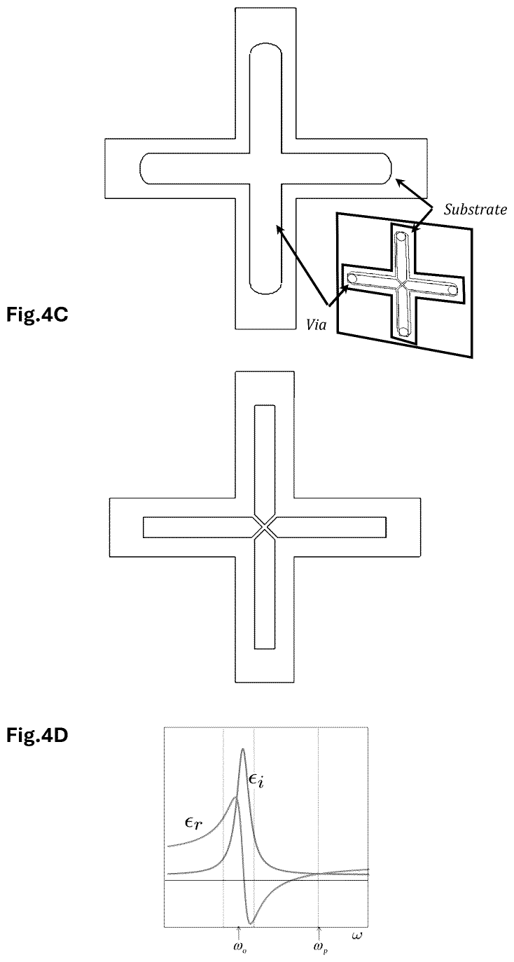

FIG. 3B shows the simulation results of the F-parameter for an MTM cover of different collision frequencies, γ for the permittivity (Up) or permeability (Down). F-parameters are used to calculate antenna coupling coefficients between nearfield or farfield sources, while S-parameters (FIG. 4A) represent the linear characteristics allowing to calculate values such as gain, loss, impedance, phase delay, and so on. S11 is the input reflection coefficient with the output of the network terminated by a matched load (a2=0). S21 is the forward transmission (from port 1 to port 2), S12 the reverse transmission (from port 2 to port 1) and S22 the output reflection coefficient. According to this figure, someone can significantly reduce the F-parameter by changing the collision frequency at a particular frequency. Since the Lorentz formula is commonly used to model dispersive materials, it yields the required permeability value to have a drop at the desired frequency. In this figure, fₚ=1.7 GHz, f₀=1.57 GHz, δ=γ=0.25×10⁹ s⁻¹, μ_{∞}=1, and μₛ=μ_{∞}+(ωₚ/ω₀)² for the Lorentz Model. The changes in the Lorentz model are significant, and the rate of changes is directly related to γ. It is interesting that it would be possible to suppress the transmitted electric field inside the cylinder at the desired frequency of f₀. For such magnetic material, the F-parameter could drop by about 40 dB or even more.

Magneto-dielectric Metamaterials, Cell Design: The constituent parameters of a magnetic candidate, the CLL cell, are investigated. FIG. 4A shows the simulated model of the MTM unit cell. To retrieve the cell's constituent parameters, the periodic response is extracted by applying electric conductor (PEC) boundaries in the xz-plane and a pair of perfect magnetic conductor (PMC) boundaries in the yx-plane. Also, a pair of wave ports is assigned on the zy-plane. The resultant scattering parameters obtained from CST microwave studio are applied to Chen's algorithm. The normalized impedance (z) and refractive index (n) of the model can be calculated as:

$$z = \pm \sqrt{\frac{{( 1 + {S}_{11} )}^{2} - {S}_{21}^{2}}{{( 1 - {S}_{11} )}^{2} - {S}_{21}^{2}}} , real ( z ) \geq 0 \qquad ( 1 )$$

$$n = \frac{1}{{k}_{0} d} \{ [ [ ln ( {e}^{ι {ńk}_{0} d} ) ] + 2 m π ] - i [ ln ( {e}^{ι {ńk}_{0} d} ) ] \}$$

where S₁₁ and S₂₁ represent the reflection and transmissions, respectively. k₀ denotes the wavenumber of the incident wave in free space, d is the slab thickness, and m is an integer related to the branch index of n. Since the metamaterial under consideration is a passive medium:

$$Im ( n ) \geq 0 , {e}^{i n {k}_{0} d} = \frac{{S}_{21}}{1 - {S}_{11} \frac{z - 1}{z + 1}} \qquad ( 2 )$$

The ambiguity of the value of m in (1) is resolved using Kramers-Kronig (K.K.) relating the real and imaginary parts of the index of refraction

$$Re ( n ( ω ) ) = 1 + \frac{2}{π} P . V . [ {\int }_{0}^{∞} \frac{{ω}^{′} Im ( n ( {ω}^{′} ) )}{{{ω}^{′}}^{2} - {ω}^{2}} d {ω}^{′} ] \qquad ( 3 )$$

where P.V. denotes the principal value of the integral and ω is the angular frequency. The effective permittivity (ε) and permeability (μ) of the medium can be expressed as ε=n/z, μ=nz. It is evident that the unit cell exhibits magneto-dielectric behavior in the frequency range of 1.4 to 1.7 GHZ, as shown in FIG. 4B. The numerical results show the Lorentz behavior for the permeability, while at f=1.575 GHz, the ∠S₁₁ is close to zero. Since the structure does not have a purely magnetic response, we expect that we will have some loss in the antenna radiation characteristics. However, some errors are usually raised due to the coupling of the cells to the antenna and the adjacent cells. Some embodiments however are generally configured with a tuning of the structure and arrangement of said metamaterial for mimicking the Lorenz model according to the radiation characteristics.

It is worth noting that many different low-profile/non-low-profile metamaterial cells could also achieve the desired magnetic response, which this patent claims all suitable configurations. FIG. 4C shows the cross-shaped low-profile CLL. Using the cross-shaped structure helps to mitigate both the vertical and horizontal fields, which consequently leads to the removal of the RHCP and LHCP components.

Polarizer Metasurface: Generally, the GPS antenna is designed to receive RCHP electromagnetic waves. Converting the unwanted incident wave polarizations into the LHCP, the interference is suppressed due to the orthogonality of these two circular polarizations. FIG. 2 shows the proposed concept. The distance between the polarizer sheet and the antenna is related to the antenna's electrical size, the ground plan, and the coupling coefficient between the antenna and the metasurface cells. The polarizer converts all linearly/circularly polarized waves into an LHCP wave. It is assumed that the unwanted signals are received in the azimuth direction. There are many options to realize the ideal response; however, this patent utilizes a new broadband, wide-angle polarizer based on chiral materials.

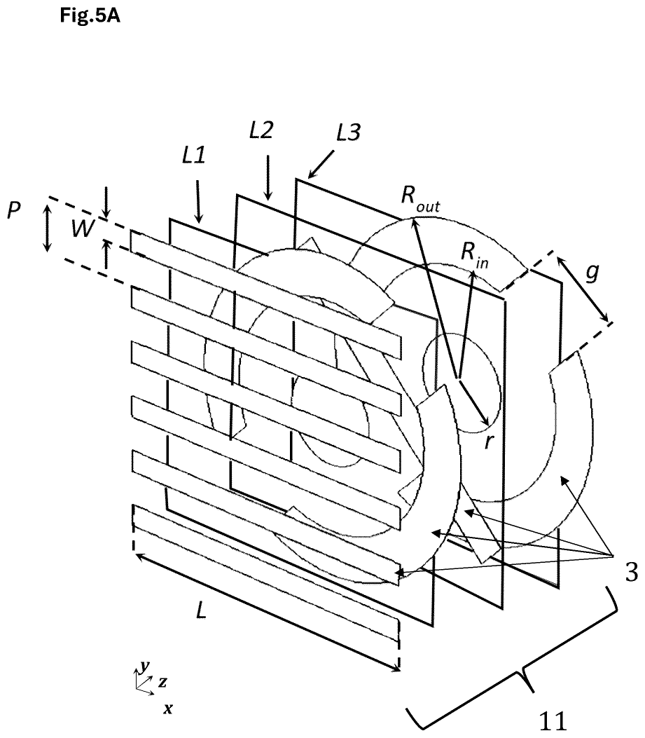

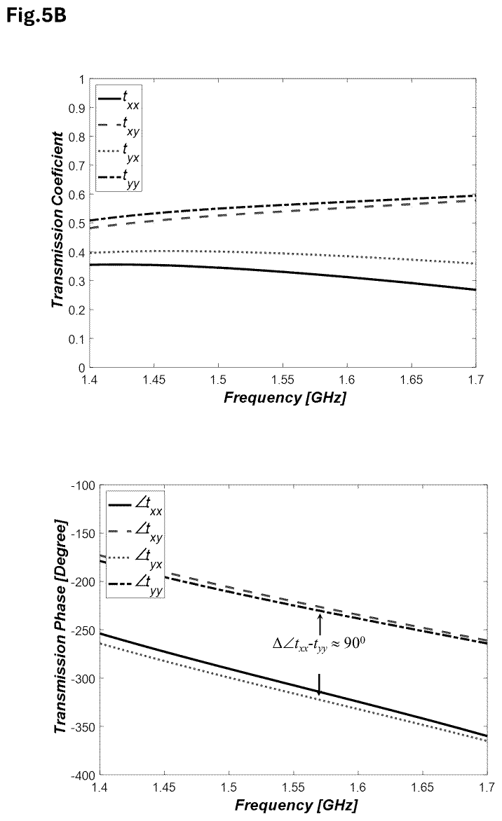

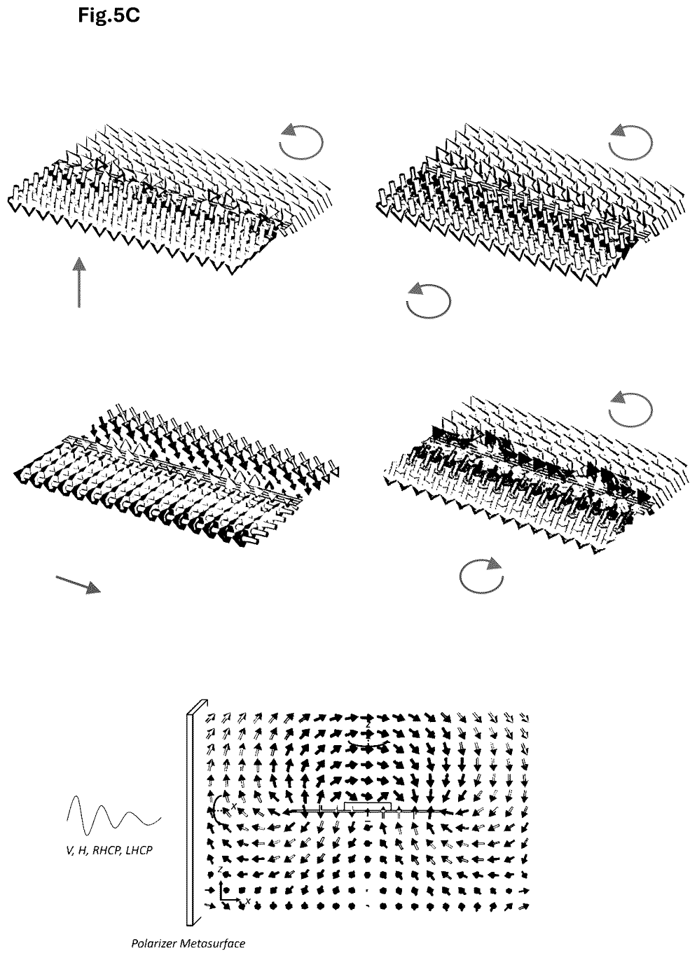

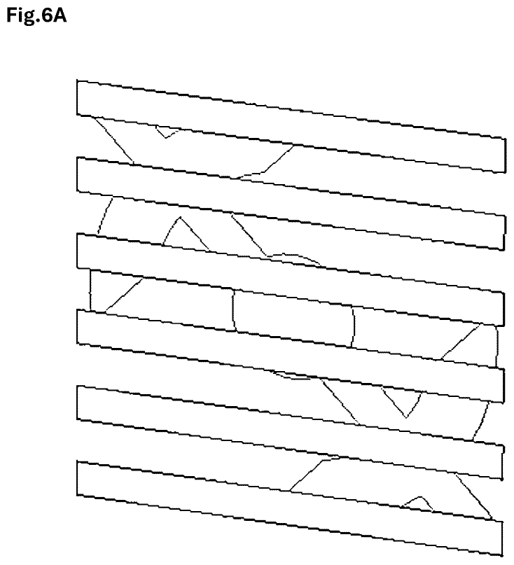

Polarizer Metasurface, Cell Design: The researchers have introduced several optical polarizers before. We present a new broadband, wide-angle polarizer that converts all incident waves with different polarizations into an LCHP wave. The structure comprises a three-layer metasurface that realizes a chiral media, as depicted in FIG. 5A. FIG. 5B shows the resulting frequency response of the cell. It seems that the phase difference between the vertical and horizontal components of the transmitted electric field is the same and equal to ±90°. FIG. 5C shows the results of the proposed polariser's numerical simulations. According to this figure, the vertical, RCHP, and LHCP polarized waves convert into LHCP polarized waves. In contrast, the polarizer reflects the horizontal linear-polarized incident wave through the desired frequency band.

Phase Shift Cancellation Metasurface: In this method, the phase difference between the transmitted wave and the reflected wave from the opposite direction is about ±π at that point. As a result, when the wave transmitted through the first metasurface meets the reflected wave from the second metasurface, they cancel each other out at the center of the setup. This canceling out is a clever way to control certain parts of the signal using phase shifts, which enhances the device's ability to manage how electromagnetic waves behave.

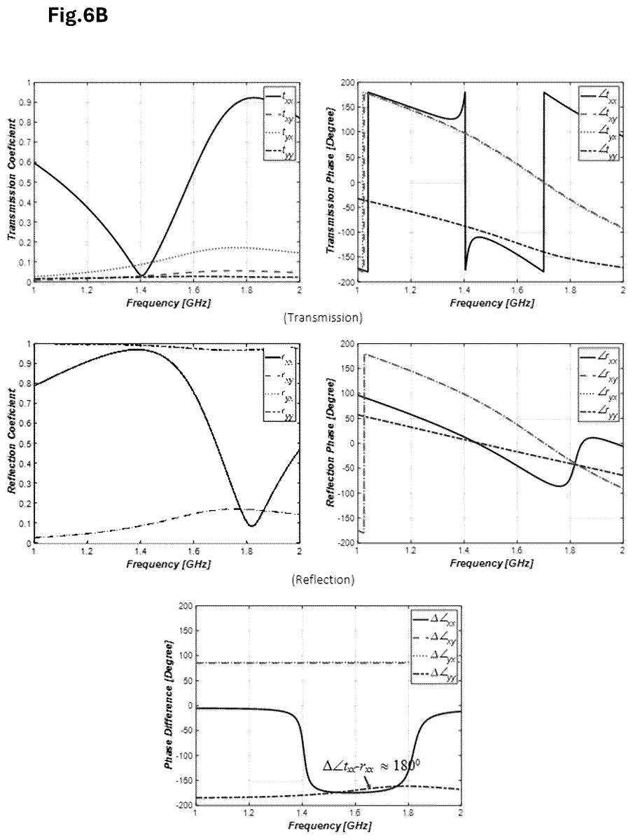

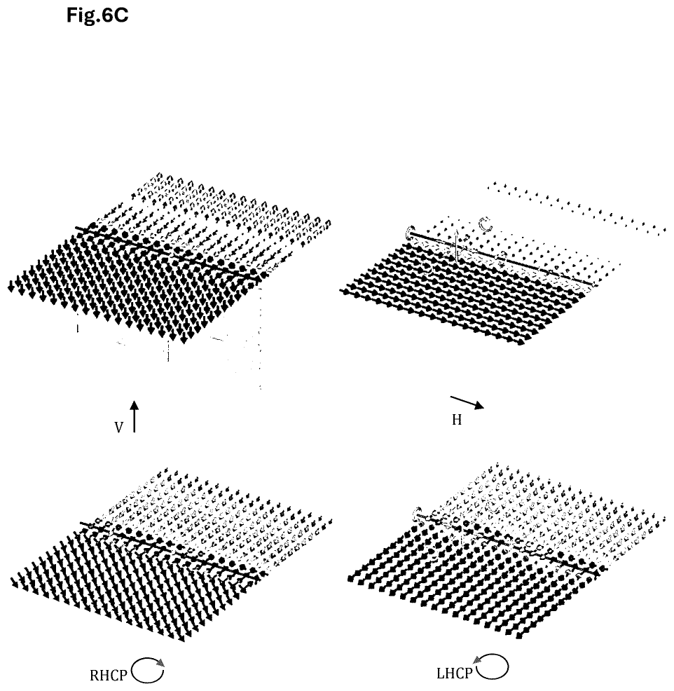

Phase Shift Cancellation Metasurface, Cell Design: The cell comprises a single-layer metasurface that realizes a chiral media, as depicted in FIG. 6A. FIG. 6B shows the resulting frequency response of the cell. It seems that the phase difference between the vertical and horizontal components of the transmitted electric field is the same and equal to ±180°. FIG. 6C shows the results of the proposed metasurface's numerical simulations.

The present invention concerns a system for electromagnetic interference cancellation in an antenna (A) suitable for receiving electromagnetic signals having a receiving direction and a frequency band, said system comprising least one cover (1) comprising at least one metamaterial, called MTM, wherein said cover (1) comprises a plurality of screens (11) extending parallel to the receiving direction (and thus generally orthogonal to the plane of the antenna), and distributed radially to surround said antenna (A) in at least one plane not parallel to the receiving direction, each screen (11) comprising at least one plate, called layer (2) of MTM, with at least one track (3) of an electrically conductive material for at least one face of each layer (2), wherein said at least one cover (1) comprises at least one type of cover among the following cover types:
A magneto-dielectric metasurface (1m) comprising screens (11) including at least one track (3), with a specific shape, juxtaposed to one face of said layer (2), for suppressing at least unwanted incident right-hand circularly polarized (RHCP) plane waves;
A metasurface polarizer (1p) comprising screens (11) including a plurality of layers (2), called L1, L2, L3, etc. (depending on their number) and a plurality of tracks (3) interposed between said layers (2) and having a specific shape for each layer (2) (i.e., for each space between the layers), for converting the incident linear/circularly polarized wave into left-hand circular polarization (LHCP);
A phase shift metasurface (1s) comprising screens (11) including at least one layer (2) with at least one track (3) on each side of the layer (2), for cancelling the transmitted and reflected waves at the antenna point and suppress the incident wave consequently.

In some embodiments, the system further comprises at least a second and/or a third MTM cover, for example as illustrated in FIG. 10, said covers being arranged concentrically around said antenna to combine their respective effects on interferences. The example shown in FIG. 10 demonstrates that the three types of covers described herein can be combined around a single antenna (microstrip patch for example), which means that only two types can be used depending on the needs and that other types might by used too.

In some embodiments, the MTM covers each comprise at least 6, preferably 8, screens (11) surrounding said antenna (A), said screens (11) having a main plane which is parallel to the receiving direction and tangential to a circle centered on said antenna (A).

In some embodiments, said screens (11) of the magneto-dielectric metasurface (1m) comprise Capacitively Loaded Loops (CLL) forming an Artificial Magnetic Conductor suppressing unwanted incident right-hand circularly polarized (RHCP) plane waves.

In some embodiments, the Capacitively Loaded Loops (CLL) of said magneto-dielectric metasurface (1m) are low-profile CLLs. In some of these embodiments, said tracks (3) of the Capacitively Loaded Loops (CLL) of said magneto-dielectric metasurface (1m) are arranged in stripes parallel to said receiving direction, thereby forming single-polarized structures mitigating polarized plane waves transmitted parallel to said receiving direction. An preferred alternative in some of these embodiments is that said tracks (3) of the Capacitively Loaded Loops (CLL) of said magneto-dielectric metasurface (1m) are arranged in crosses having branches parallel to said receiving direction and branches orthogonal to said receiving direction, to mitigate all polarizations, thereby forming dual-polarized structures suppressing polarized waves in two directions and thus lead to a reduction in both left-hand circular polarization (LHCP) and right-hand circular polarization (RHCP).

In some embodiments, said screens (11) of the metasurface polarizer (1p) comprise chiral MTM. In some embodiments, said screens (11) of the metasurface polarizer (Ip) comprise a first dielectric layer (L1), on which the tracks (3) are periodic metallic ribbons, which are printed using a PCB (Printed Circuit Board) technology for example, a printing process widely known. On the back of this layer, a gapped circular structure is printed and rotated 45 degrees. The back of the second layer features a ribbon that is oriented perpendicular to the gap angle of the circular structure. The third layer has a circular structure on its back, identical to the one on the second layer. The first metallic layer filters the parallel component of the electric field, allowing the perpendicular wave to transmit. The second circular metallic shape then causes a rotation of this transmitted wave. The third rotated ribbon and the fourth circular shape further rotate the transmitted field perfectly. The position of the gap and the rotated ribbon determines the type of polarization output, which in this case is LHCP. Because the converter usually has different properties in near fields compared to the far fields, it is usually not expected to have the polarizer working in the near field. However, in the present case, the antenna can be very close to the MTM and the latter can thus also filter the near filed interferences. Thus, in some embodiments, the distance between said MTM and the antenna is reduced according to both the near field and the far-field, to obtain a short distance enabling said system to act as a polarizer converter in the near-filed in addition to the far-field.

In some embodiments, said screens (11) of the phase shift (1s) comprise chiral MTM.

In some embodiments, said screens (11) of the phase shift (1s) comprise a single-layer MTM cell, which is a dielectric layer (2) provided, on one face, with a plurality of parallel and periodic tracks (3) oriented orthogonally to said receiving direction, and on the opposite face, with a track (3) having a gapped circular (crown) shape, integrated with a ribbon rotated 45 degrees, thereby creating a 180-degree phase shift between the wave transmitted from the front and the wave reflected from the back of the antenna.

A magneto-dielectric metamaterial is an appropriate cover that can suppress the incident plane-wave interference. The low-profile CLL is a good candidate that is employed to realize the required effective medium. It is shown that the MTM cell exhibits the desired permeability in the antenna operating frequency. It is worth noting that the cell could replace any magnetic metamaterial cells that can provide similar magneto-dielectric behavior.

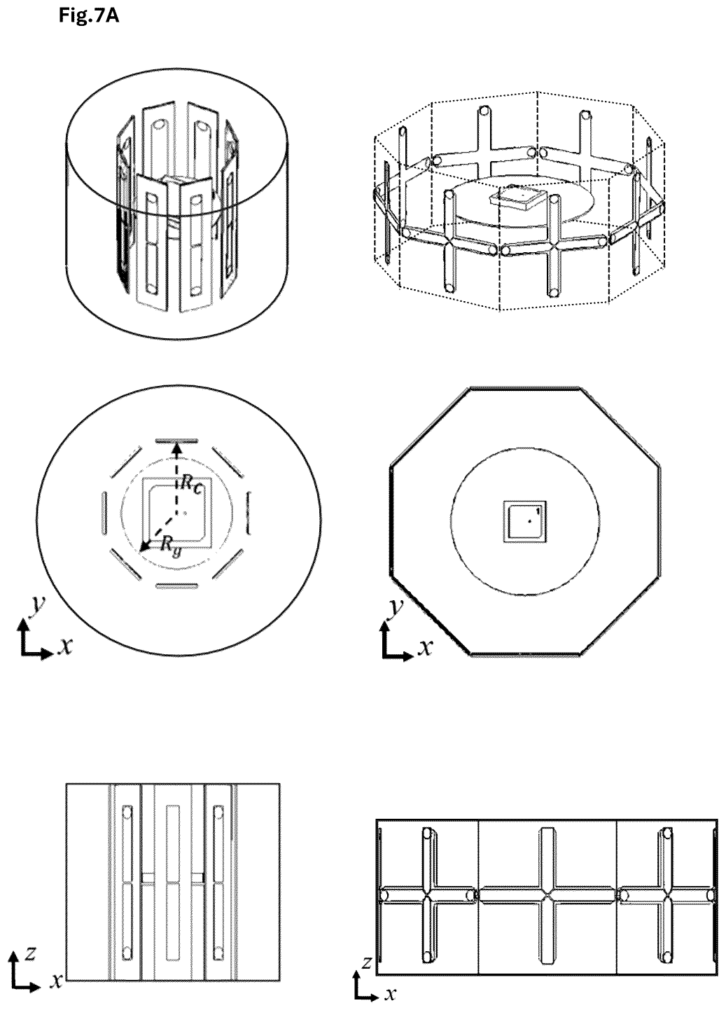

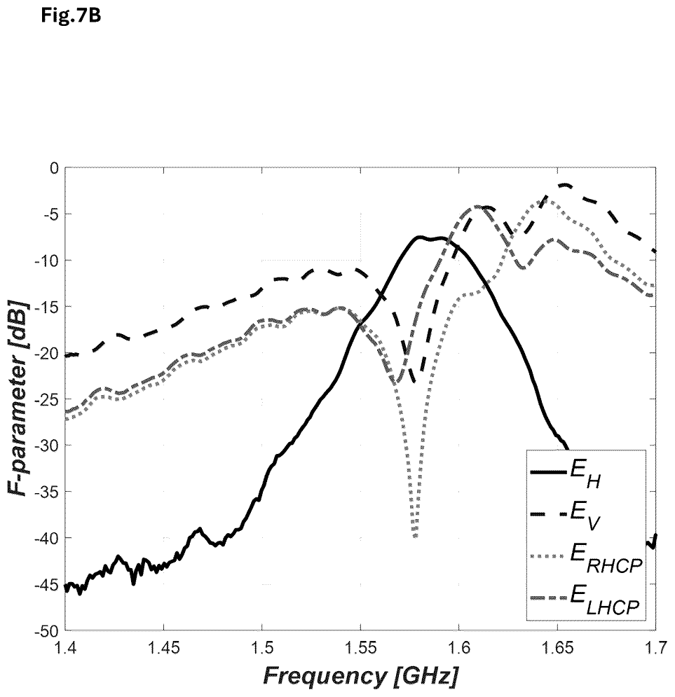

Using low-profile CLL, the final structure contains several cells radially located around a microstrip patch antenna (FIG. 7A) that operates at GPS-L1 frequency (f=1.575 GHz). Since the cells do not configure periodically, the structure is usually called a metamaterial-inspired structure in the literature. Two discs of Rohacell with a dielectric constant of 1 are used to fix the cells at an equispaced distance apart.

FIG. 7B compares the antenna's F-parameters with and without the Low-profile CLLs. According to this figure, the MTM helps suppress the incident plane wave of more than 30 dB. The antenna impedance bandwidth (|S₁₁|−10 dB) of 1.14% from 1.561 to 1.579 GHz (18 MHz) is observed. It should be noted that the presence of the CLL-MTM does not significantly affect the antenna matching condition. Notably, the result shows the interference cancellation of more than 30 dB.

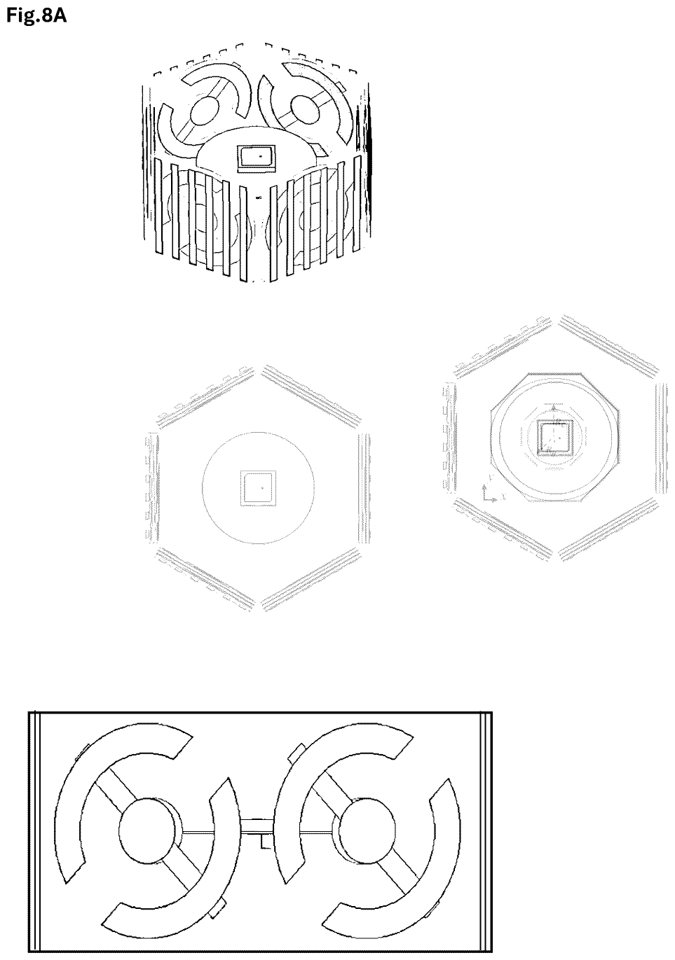

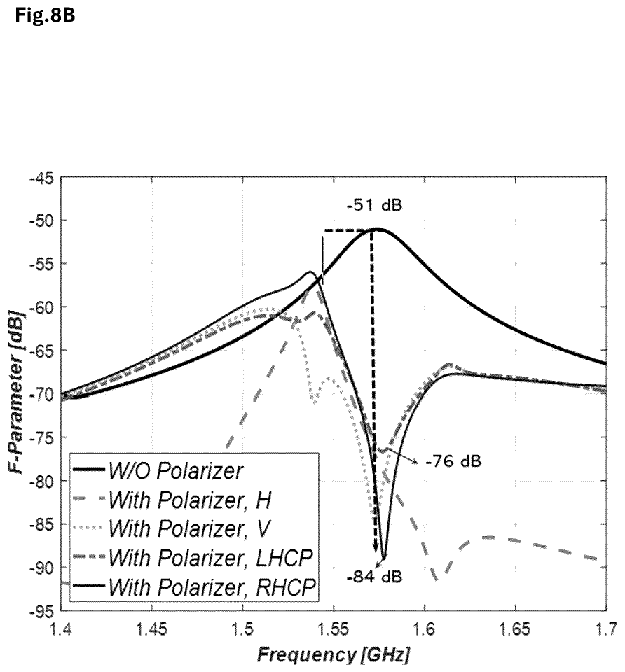

Using the proposed polarizer metasurface, the final structure containing several cells radially located around a microstrip patch antenna that operates at GPS-L1 frequency (f=1.575 GHz) is illustrated in FIG. 8A. The antenna design parameters are like the previous design and do not change here. The polarizer cells do not configure periodically in a perfect manner. To fabricate the antenna prototype, two discs of Rohacell with a dielectric constant of 1 are used to fix the cells at an equispaced distance apart.

FIG. 8B compares the F-parameter of the antenna with and without the polarizer metasurface for an incident plane wave with linear and right-hand circular polarization. According to this figure, the polarizer helps suppress the incident plane wave of more than 40 dB for linear vertical polarization. At the same time, it leads to about 30 dB enhancement for the RCHP incident wave. The numerical simulations show that the presence of the polarizer does not have considerable effects on the antenna matching condition and radiation performance.

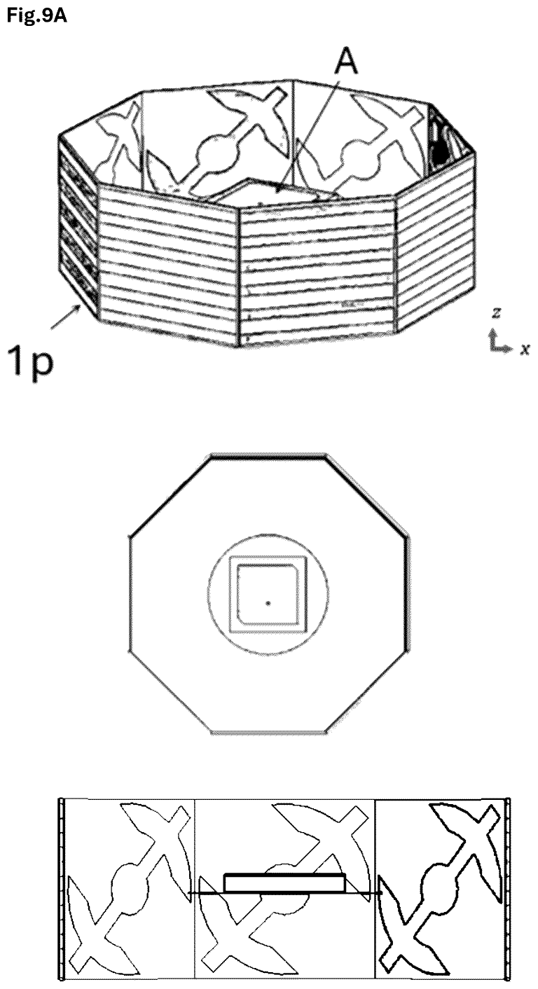

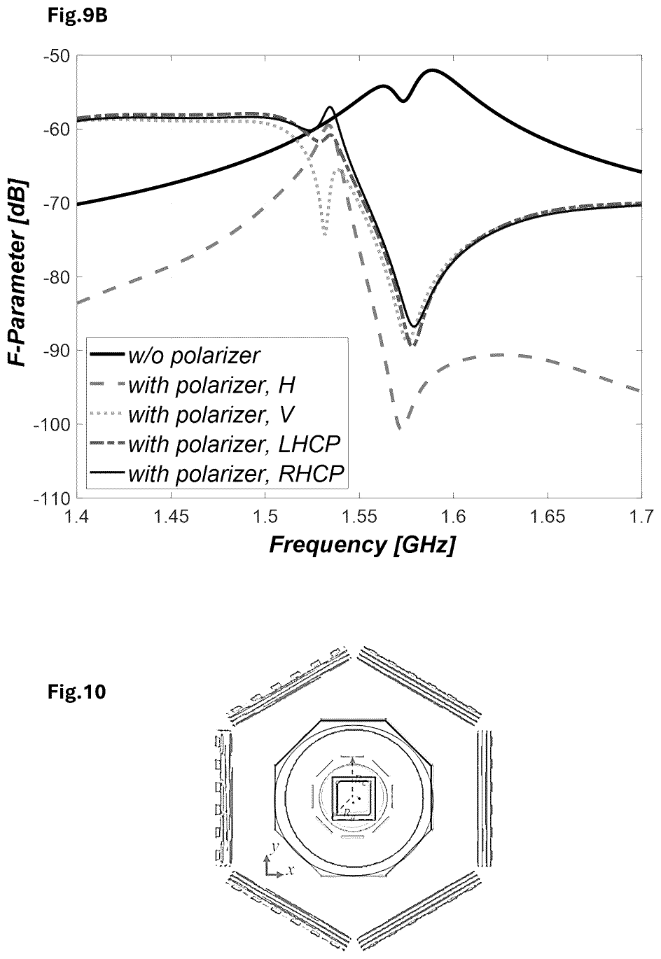

Employing the proposed phase-shift cancellation metasurface, the final structure containing several cells radially located around a microstrip patch antenna that operates at GPS-L1 frequency (f=1.575 GHz) is illustrated in FIG. 9A. The antenna design parameters are like the previous design and do not change here. To fabricate the antenna prototype, two discs of Rohacell with a dielectric constant of 1 are used to fix the cells at an equispaced distance apart.

FIG. 9B compares the antenna's F-parameter with and without the phase-shift cancellation metasurface for an incident plane wave with linear and right-hand circular polarization. According to this figure, the metasurface helps suppress the incident plane wave by more than 40 dB for linear horizontal polarization. At the same time, it leads to about 30 dB enhancement for the RCHP incident wave. The numerical simulations show that the presence of the metasurface does not have considerable effects on the antenna matching condition and radiation performance.

The proposed systems are low-cost, passive structures based on loading patch antennas radially using magneto-dielectric metamaterial or a metasurface-based polarizer or phase-shift cancellation.

The magneto-dielectric structure, the cross-shaped structure, enables the cancellation of a plane-wave interference that is received by the antenna at the azimuth plane.

The metasurface-based polarizer converts the incident linear/circularly polarized waves into an LHCP wave and consequently causes a significant reduction of receiving unwanted signals through the wide elevation angle due to the right-hand circular polarization nature of the traditional GPS antennas.

The phase difference between the transmitted wave and the reflected wave from the opposite direction in the phase-shift cancellation metasurface is about ±π at that point. As a result, when the wave transmitted through the first metasurface meets the reflected wave from the second metasurface, they cancel each other out at the center of the setup. This canceling out is a clever way to control certain parts of the signal using phase shifts, which enhances the device's ability to manage how electromagnetic waves behave.

The proposed structure offers an efficient solution to suppress unwanted interference that does not depend on the direction of the incident at the azimuth plane.

A magneto-dielectric material can be realized either by a low-profile capacitively-loaded loop (CLL) structure or any magnetic metamaterials with different cell configurations that can provide similar magneto-dielectric behavior, including low-profile or non-low-profile structures.

A metasurface polarizer converts incident linear or circularly polarized waves into a wave with an LCHP polarization. Various configurations could realize the metasurface polarizer; however, this patent utilized a new broadband wide-angle chiral metasurface.

A phase-shift cancellation metasurface mitigates incident linear or circularly polarized waves. Various configurations could realize the metasurface; however, this patent utilized a new broadband wide-angle single-layer chiral metasurface.

To cancel non-azimuth incident interference, this patent claims a symmetrical spherical conformal structure that estimates the direction of arrival of the interference and then reconfigures the metamaterial elements (including both magneto-dielectric and metasurface) to suppress the incident wave efficiently. To do this, the metamaterial structures are designed to be symmetric or arranged in a symmetric way while they are reconfigurable.

This patent claims to employ an array of GPS antennas to cancel incident interference efficiently. Using an array of antennas gives one more freedom to achieve enhanced suppression. As a result, all side-lobe reduction/back-lobe reduction approaches in combination with the proposed system and methods are included within the claims of this patent.

One or more embodiments of the present invention present a new method and/or structure to suppress deliberate or unintentional interference in conventional GPS microstrip antennas. The antenna constitutes a microstrip patch loaded radially by a metamaterial cover. Three different approaches have been proposed to implement the cover: the first one is a magneto-dielectric material, the second one is a metasurface polarizer, and the third one is the phase-shift cancellation metasurface. An artificial magnetic conductor (AMC) is utilized to realize the magneto-dielectric cover. A cross-shaped low-profile CLL is proposed to realize the desired AMC materials and mitigate the unwanted plane wave with different polarizations. In the second approach, the metasurface polarizer converts the incident linear/circularly polarized wave into left-hand circular polarization (LHCP). Consequently, it causes a significant reduction in receiving unwanted signals due to the RHCP nature of the GPS antenna. The phase difference between the transmitted wave and the reflected wave from the opposite direction in the phase-shift cancellation metasurface is about ±π at that point. Many different types of metamaterial structures can realize the polarizer and phase-shift cancellation; however, chiral-engineered materials are employed in this patent. The chiral metamaterials can manipulate the transmitted waves due to their anisotropic essence. The essential features of the suggested antenna are low cost, compact size, ease of design, no need to implement a complex array with sophisticated signal processing, and the use of a simple passive structure. Although the structure is proposed to cancel unwanted signals and interference in GPS applications, this method can be generalized in other wireless applications and through the entire frequency band.

1. A system for electromagnetic interference cancellation in an antenna (A) suitable for receiving electromagnetic signals having a receiving direction and a frequency band, said system comprising least one cover (1) comprising at least one metamaterial, called MTM, wherein said cover (1) comprises a plurality of screens (11) extending parallel to the receiving direction, and distributed radially to surround said antenna (A) in at least one plane not parallel to the receiving direction, each screen (11) comprising at least one plate, called layer (2) of MTM, with at least one track (3) of an electrically conductive material for at least one face of each layer (2), wherein said at least one cover (1) comprises at least one type of cover among the following cover types:
a magneto-dielectric metasurface (1m) comprising one or more screens of the plurality of screens (11) including at least one track (3), with a specific shape, juxtaposed to one face of said layer (2), configured to suppress at least unwanted incident right-hand circularly polarized (RHCP) plane waves;
a metasurface polarizer (1p) comprising one or more screens of the plurality of screens (11) including a plurality of layers (2) and a plurality of tracks (3) having a specific shape for each layer (2) and interposed between said layers (2), configured to convert the incident linear/circularly polarized wave into left-hand circular polarization (LHCP); or
a phase shift metasurface (1s) comprising one or more screens of the plurality of screens (11) including at least one layer (2) with at least one track (3) on each side of the layer (2), configured to cancel the transmitted and reflected waves at the antenna point and suppress the incident wave consequently.

2. The system according to claim 1, further comprising at least a second and/or a third MTM cover, said covers being arranged concentrically around said antenna to combine their respective effects on interferences.

3. The system according to claim 1, wherein the MTM covers each comprise at least 6 screens of the plurality of screens (11) surrounding said antenna (A), said 6 screens (11) having a main plane which is parallel to the receiving direction and tangential to a circle centered on said antenna (A).

4. The system according to claim 1, wherein said one or more screens of the plurality of screens (11) of the magneto-dielectric metasurface (1m) comprise Capacitively Loaded Loops (CLL) forming an Artificial Magnetic Conductor configured to suppress unwanted incident right-hand circularly polarized (RHCP) plane waves.

5. The system according to claim 4, wherein the Capacitively Loaded Loops (CLL) of said magneto-dielectric metasurface (1m) are low-profile CLLs.

6. The system according to claim 5, wherein said tracks (3) of the Capacitively Loaded Loops (CLL) of said magneto-dielectric metasurface (1m) are arranged in stripes parallel to said receiving direction, thereby forming single-polarized structures configured to mitigate polarized plane waves transmitted parallel to said receiving direction.

7. The system according to claim 5, wherein said tracks (3) of the Capacitively Loaded Loops (CLL) of said magneto-dielectric metasurface (1m) are arranged in crosses having branches parallel to said receiving direction and branches orthogonal to said receiving direction, to mitigate all polarizations, thereby forming dual-polarized structures configured to suppress polarized waves in two directions and thus lead to a reduction in both left-hand circular polarization (LHCP) and right-hand circular polarization (RHCP).

8. The system according to claim 1, further configured with a tuning of the structure and arrangement of said magneto-dielectric metasurface (1m) for mimicking the Lorenz model according to the radiation characteristics.

9. The system according to claim 1, wherein said one or more screens of the plurality of screens (11) of the metasurface polarizer (1p) comprise chiral MTM.

10. The system according to claim 1, wherein said one or more screens of the plurality of screens (11) of the metasurface polarizer (1p) comprise a first dielectric layer (L1) and the outer tracks (3) are periodic metallic ribbons on the outer face of the layer (L1), configured to filter the parallel component of the electric field, allowing the perpendicular wave to transmit.

11. The system according to claim 10, wherein said one or more screens of the plurality of screens (11) of the metasurface polarizer (1p) include, on the inner face of this layer (L1), a gapped circular track which is rotated 45 degrees.

12. The system according to claim 10, wherein the inner (or back) face of the second layer (L2) features a ribbon that is oriented perpendicular to the gap angle of the circular structure.

13. The system according to claim 10, wherein the third layer (L3) has a circular structure on its back, identical to the one on the second layer.

14. The system according to claim 10, wherein the third rotated ribbon and a fourth circular shape further rotate the transmitted field perfectly, with the position of the gap and the rotated ribbon determining the type of polarization output, which in this case is LHCP.

15. The system according to claim 1, wherein said one or more screens of the plurality of screens (11) of the phase shift (1s) comprise chiral MTM.

16. The system according to claim 1, wherein the distance between said MTM and the antenna is reduced according to both the near field and the far-field, to obtain a short distance enabling said system to act as a polarizer converter in the near-field in addition to the far-field.

17. The system according to claim 1, wherein said one or more screens of the plurality of screens (11) of the phase shift (1s) comprise a single-layer MTM cell, which is a dielectric layer (2) provided, on one face, with a plurality of parallel and periodic tracks (3) oriented orthogonally to said receiving direction, and on the opposite face, with a track (3) having a gapped circular (crown) shape, integrated with a ribbon rotated 45 degrees, thereby creating a 180-degree phase shift between the wave transmitted from the front and the wave reflected from the back of the antenna.

18. The system according to claim 3, wherein the MTM covers comprise at least 8 screens of the plurality of screens.

19. The system according to claim 1, wherein the specific shape includes at least one of a stripe, a band, or a branch, and the specific shape is in parallel, crossing, straight, or circular.
